(19) United States
(12) Patent Application Publication
(10) Pub. No.: US 2017/0156541 A1
(43) Pub. Date: Jun. 8, 2017

(54) A CUP-SHAPED CONTAINER CAPABLE OF BEING CONVERTED INTO DUTCH COFFEE MACHINE

(71) Applicant: HUMMING PAPER CO.LTD, Gyeonggi-do (KR)

(72) Inventors: Jung-hoon BAE, Seoul (KR); Ji-hoon BAE, Seoul (KR)

(73) Assignee: HUMMING PAPER CO.LTD, Gyeonggi-do (KR)

(21) Appl. No.: 15/323,597

(22) PCT Filed: May 27, 2015
(86) PCT No.: PCT/KR2015/005307

§ 371 Date: Jan. 3, 2017

(30) Foreign Application Priority Data
Jul. 1, 2014 (KR) 10-2014-0081950

(51) Int. Cl. A47J 31/02; A47J 31/44; B65D 25/38; A47J 31/06

(52) U.S. Cl. CPC A47J 31/02; A47J 31/06; A47J 31/44; B65D 25/38

(57) ABSTRACT

A cup-shaped container capable of being converted into a Dutch coffee machine includes a main body of cup-shape, a drainer protrusion protruding outward from the bottom surface of the main body, and a drain hole to connect to an inside of the drainer protrusion and an inside of the main body. The cup-shaped container can be used as a cup in normal times and can be converted into a Dutch coffee machine by simple operation when necessary.

### BACKGROUND

1. Technical Field

Example embodiments relate to a cup-shaped container capable of being converted into Dutch coffee machine. More particularly, the present inventive relates to a cup-shaped container used as a cup in normal times and capable of being converted into Dutch coffee machine by simple operation when necessary.

2. Description of the Related Art

A Dutch coffee is a brewed coffee using cold water or room temperature water using not a hot water, also called cold brew. The Dutch coffee refers to a coffee made by putting ground beans in a special appliance and by extracting the ground beans for 3 to 4 hours in short, or for 8 to 12 hours in long in the cold water or the room temperature water. A method of extracting the Dutch coffee is classified into a drip method and an infusion method. The drip method refers to a way in which the brewed coffee from a container is dropped by one drop. The infusion method refers to a way to soak and brew the ground beans in the cold water or the room temperature water for a long time. A cup-shaped container capable of being converted into a Dutch coffee machine according to the present invention relates to a cup-shaped container that can make the Dutch coffee by employing the drip method.

The Dutch coffee is less bitter than a regular coffee which is extracted in hot water in a short time, and has a mild and soft flavor, therefore, attracted a lot of attention recently. But, because a Dutch coffee machine is expensive and cumbersome to use, a person who make and eat once in a while can be burdensome to purchase and use the Dutch coffee machine. Moreover, the person may be burdensome to manufacture the Dutch coffee machine due to the complex or cumbersome equipment as the Dutch coffee only needs to brew coffee beans in cold water in any way.

A method to make the Dutch coffee using a plastic container is to prepare three cups (e.g., plastic cups) of a coffee shop for take-out, to drill on the bottom of two of the three cups but not to drill one of the three cups. After that, the method is to place the one cup with no hole in the bottom at the bottom and to vertically stack the two cups with hole on top of the one cup, and then the three cups are stacked vertically. At this time, the method is to place coffee beans in the middle cup, and put cold water in the uppermost cup so that the cold water is dropped by one drop into the middle cup. So, the water in the uppermost cup drops slowly into the middle cup and brews the coffee beans, and then condensed liquid goes down to the bottom cup such that the condensed liquid of the Dutch coffee may be made.

The method that has been used in the past for some consumers has an advantage of being able to enjoy the Dutch coffee at low cost. But, Drilling a hole neatly on the bottom of the cup is not easy, failure to adjust the size of the hole causes the water drop to speed up or to become too slow, and causes a lot of inconvenience to use for a novice.

In particular, because most plastic cup containers have a flat bottom surface and must apply force vertically using an awl or a similar instrument to drill a hole, drilling a hole of required size is not easy for a novice (or a beginner), and even a person with some skill may have a burr around the hole such that the cup becomes dirty. A dirty utensil making food may not be a big problem when enjoying the Dutch coffee alone, but may not be appropriate to be enjoyed with guests for hygiene or appearance. Therefore, a versatile container for making good quality coffee may be good for a novice to make and use easily with no problem for hygiene and appearance.

### SUMMARY

Some example embodiments provide a cup-shaped container used as a cup in normal times and capable of being converted into a Dutch coffee machine by a simple operation when necessary.

According to example embodiments, a cup-shaped container capable of being converted into a Dutch coffee machine may include a main body of cup-shape; a drainer protrusion with a closed structure protruded to outside from a bottom surface of the main body; and a drain hole to connect an inside of the main body and an inside of the drainer protrusion. Here, the cup-shape container may be converted into a Dutch coffee machine by cutting off the drainer protrusion.

In example embodiments, the drain hole is formed to be narrowed toward the outside.

In example embodiments, the cup-shaped container may further include an expansion hole formed between the drain hole and inner bottom surface of the main body and to become wider toward the inner side of the bottom surface of the main body.

In example embodiments, each of the drain hole and the drainer protrusion may be formed in a conical shape, and the expansion hole may have a cone angle larger than a cone angle of the drain hole such that the overall shape is a funnel shape.

In example embodiments, the cup-shaped container may further include a cover on an upper opening of the main body, where a through hole is formed in a center of the cover corresponding to the drain hole.

In example embodiments, the cup-shaped container may further include a mounting frame on the cover and around the through hole, where a lower part of the main body is mounted on the mounting frame.

According to example embodiments, a Dutch coffee machine may include a first main body which accepts finally a brewed coffee; a first cover mounted on an upper part of the first main body; a second main body including a drain hole on a bottom surface corresponding to a through hole of the first cover and brewing a coffee; a second cover mounted on an upper part of the second main body; and a third main body including a drain hole on a bottom surface corresponding to a through hole of the second cover and accepting water.

In example embodiments, the second main body may include a filter on a bottom surface of the second main body. Here, grinded coffee beans may be included on an upper part of the filter, the water contained in the third main body may flow into the second main body and brews the coffee beans, and the brewed coffee may flow out to the first main body.

In example embodiments, the second main body and the third main body may include a drainer protrusion protruding outward from the bottom surface and including a drain hole inside. Here, the drainer protrusion and the drain hole may be formed to be narrowed outward.

In example embodiments, the second main body may further include an expansion hole formed between the drain hole and inner bottom surface of the second main body and to become wider toward the inner side of the bottom surface of the second main body. Here, the expansion hole may have a cone angle larger than a cone angle of the drain hole such that overall shape of the drain hole and the expansion hole may be a funnel shape.

Therefore, a cup-shaped container capable of being converted into Dutch coffee machine according to example embodiments may be used as a multipurpose cup in general and may be converted into a Dutch coffee machine. In addition, a cup container capable of being converted into Dutch coffee machine according to the present invention has a structure in which the center of the bottom surface of the cup is protruding, so that the cup container may be cut and used neatly in the lateral direction with a simple cutting tool. Since the size of the hole changes depending on the position of the cut, the speed at which water flows down may be adjusted.

### BRIEF DESCRIPTION OF THE DRAWINGS

Illustrative, non-limiting example embodiments will be more clearly understood from the following detailed description taken in conjunction with the accompanying drawings.

FIG. 1 is a diagram illustrating a composition of a cup-shaped container capable of being converted into Dutch coffee machine according to example embodiments.

FIG. 2 is a diagram illustrating a state of implementation of a cup-shaped container capable of being converted into Dutch coffee machine according to example embodiments.

### DESCRIPTION OF EMBODIMENTS

Hereinafter, the present inventive concept will be explained in detail with reference to the accompanying drawings.

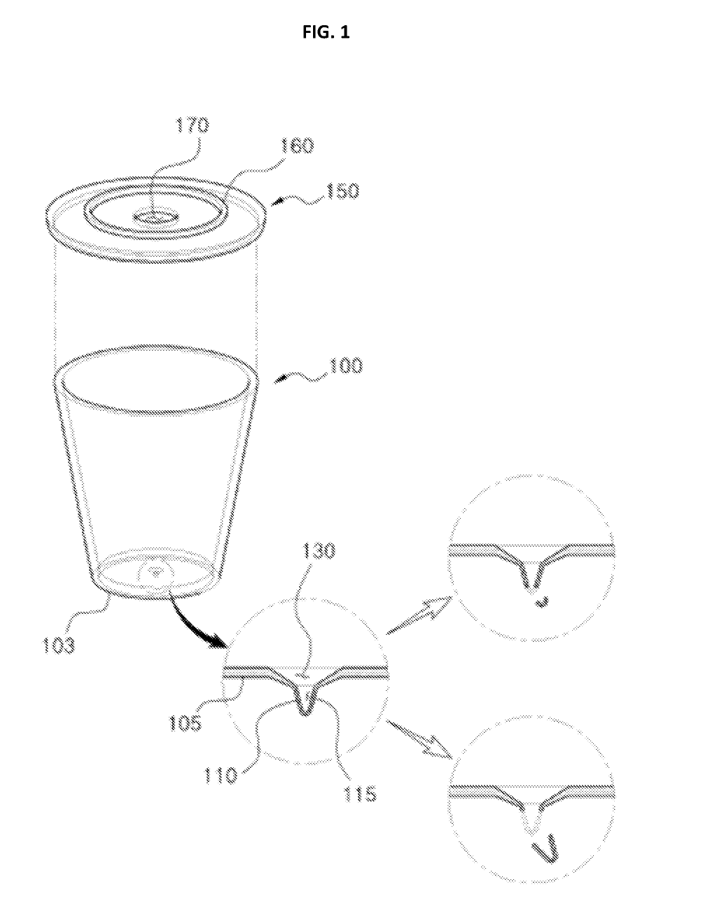

FIG. 1 is a diagram illustrating a composition of a cup-shaped container capable of being converted into a Dutch coffee machine according to example embodiments.

Referring to FIG. 1, the cup-shaped container capable of being converted into a Dutch coffee machine may include a main body 100 and a cover (or a lid part) 150. The cup-shaped container may include a drainer protrusion 110 formed in a bottom surface of the main body 100.

The main body 100 may be formed in a cylinder shape or a polygonal cylinder shape with an open (or an opening) upper part and a closed lower part. Preferably, as shown in FIG. 1, the main body may have a shape that inner and outer diameters become smaller from the upper part (refers a direction indication based on FIG. 1) to the lower part. However, the composition shows a preferred example of the present invention, a variety of known shapes may be used as long as the shape of a cup. For example, the cup-shaped container may include a main body having a vertical or curved shape in upward and downward directions and an elliptical upper part section. In addition, as long as the main body may accommodate a liquid material and do not interfere with the implementation of function of the present invention, the cup-shaped container may be changed to various known cup structures. Meanwhile, the thickness of the side surface and the bottom surface of the main body 100 may be varied in consideration of the use and the selling price, the thickness of the cup-shaped container and the like do not greatly affect the implementation of the function of the present invention. Hereinafter, the concrete composition and implementation of the cup-shaped container capable of being converted into a Dutch coffee machine will be explained based on the cup shape shown in the drawings.

A drainer protrusion 110 may be formed (or included) in the lower bottom surface 105 of the main body 100. The drainer protrusion 110 may be a closed structure protruding outward from the lower bottom surface of the main body 100 and may include a drain hole 115 connected to inside of the main body 100. In example embodiments, the drainer protrusion 110 may be structured so as to have a narrower width toward the outside (refers to the lower direction in FIG. 1). In an example embodiment, the drainer protrusion 110 may have a conical shape. Here, the drain hole 115 included in inside of the drainer protrusion 110 may be structured so as to become narrower toward the outside. Thus, as will be explained later, the size of a hole may be determined according to the cutting point of the drainer protrusion 110. Cutting of the drainer protrusion 110 and a function and the like of the drainer protrusion 110 will be explained later in detail.

On the other hand, the drainer protrusion 110 may include a cutting groove (not shown) as needed. The cutting groove have a structure in which a specific position of the drainer protrusion 110 is recessed in the circumferential direction so that the both side based on the cutting groove may be cut easily. The drainer protrusion 110 may have one or more cutting groove as needed. For example, example embodiment in which an end hem and a starting hem (e.g., parts adjacent to the bottom surface 105 of the main body 100) of the drainer protrusion 110 are cut is illustrated in FIG. 1, a cutting groove may be respectively included in (or formed at) portions to be cut. The cutting groove may be included mainly when the main body 100 and/or the drainer protrusion 110 are relatively thick and hard. Thus, the drainer protrusion 110 may be cut based on the cutting groove when lightly hit the side. However, when the drainer protrusion 110 can be easily cut by a cutting tool such as a knife, the cutting groove may not be necessarily included.

Because the drainer protrusion 110 is formed to be narrowed toward outside, the size of the hole formed according to the position of cutting the drainer protrusion 110 may be changed. That is, the closer a cutting portion is to the end hem of the drainer protrusion 110, the smaller size of the hole may be formed. The closer the cutting portion is to the starting hem of the drainer protrusion 110, the larger size of the hole may be formed. Thus, the amount of liquid discharged differs depending on the size of the hole.

A support base 103 may be further included in a lower edge of the main body 100. The support base 103 may be longer than the length of a drainer protrusion 110 explained above so that the drainer protrusion 110 may be separated (or spaced apart) from the bottom surface when a cup-shaped container is placed on the bottom.

An expansion hole 130 may be further included in the bottom surface 105 of the main body 100. The expansion hole 130 may be formed between the drainer protrusion 110 included outside of the bottom surface 105 of the main body 100 and inner surface of the main body 100 and may be connected to the drain hole 115 and also to an inner space of a main body 100. Thus, when the drainer protrusion 110 is cut at one portion and the drain hole 115 is exposed, the liquid contained in the main body 100 may flow out of the bottom surface 105 of the main body 100 sequentially through the expansion hole 130 and the drain hole 115. An expansion hole 130 may be formed to be wider from the outer side to the inner side of the bottom surface 105 of the main body 100, a cone angle of the extension hole 130 may be larger than a cone angle of the drain hole 115. Here, the cone angle refers to the angled angle of a pointed portion. Thus, the expansion hole 130 and the drain hole 115 may be connected to each other in a funnel shape. A function of the expansion hole 130 will be explained later.

The cup-shaped container capable of being converted into a Dutch coffee machine may further include a cover 150 located on an upper opening of the main body 100. The cover 150 may include a through hole 170 at a center of the cover 170 and may be formed at a corresponding point which corresponds to the drain hole 115 when the main body 110 is mounted on the cover 150. Here, the corresponding point may connect the drain hole 115 and the through hole 170 when the main body 110 is mounted on the cover 150 such that a liquid may flow out from the drain hole 115 through the through hole 170 directly.

In example embodiments, the cup-shaped container capable of being converted into a Dutch coffee machine may further include a mounting frame 160 around the through hole 170. The mounting frame 160 may be a protruded shape above the cover 150. An inner periphery of the mounting frame 160 may be formed with a shape corresponding to the bottom of the main body 100. The mounting frame 160 may be larger than a bottom periphery of the main body 100. Therefore, the main body 100 may be inserted into the mounting frame 160 when the main body 100 is mounted on the mounting frame 160.

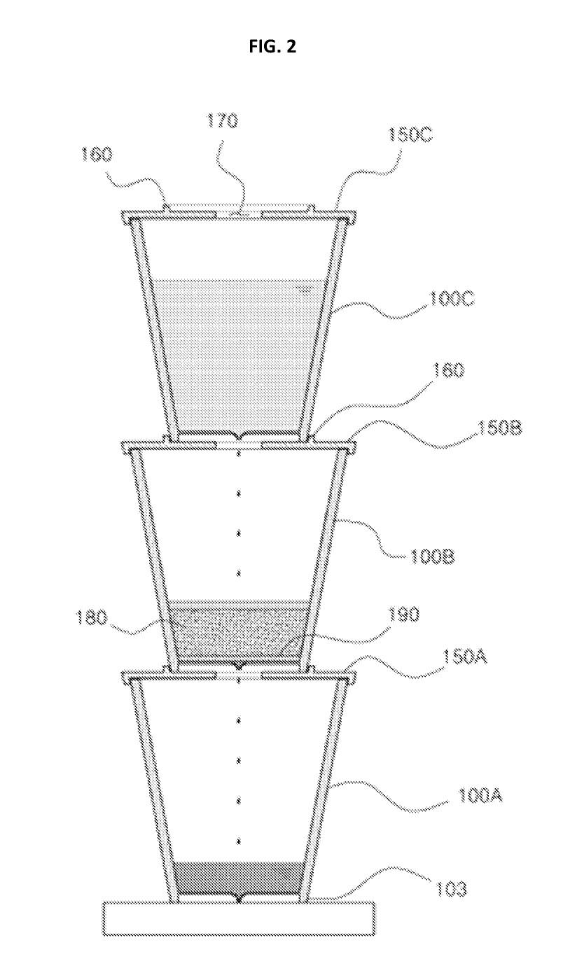

FIG. 2 is a diagram illustrating a state of implementation of a cup-shaped container capable of being converted into Dutch coffee machine according to example embodiments.

Referring to FIG. 2, the Dutch coffee machine according to example embodiments may include a first main body 100A, a first lid part (or first cover) 150A mounted on the first main body 100A, a second main body 100B mounted on an upper part of the first lid part 150A, a second lid part (or second cover) 150B mounted on the second main body 100B, and a third main body 100C mounted on an upper part of the second lid part 150B. Here, the first, second, and third main bodies 100A, 100B, and 100C may have the same composition as (or may be the same as or similar to) the main body 100 explained above. The first lid part 150A, second lid part 150B, and the third lid part 150C which is explained later have the same composition as (or may be the same as or similar to) the cover (or the lid part) 150 explained above.

First, the first main body 100A accepts finally a brewed coffee. Therefore, the first main body 100A may be used in a form in which the drain hole 115 in not cut. The first lid part 150A may be mounted on the upper part of the first main body 100A. The first lid part 150A may prevent foreign maters from entering into the first main body 100A and may allow the second body 100B to be easily mounted. The second main body 100B may be mounted to the upper part of the first lid part 150A. At this time, the second main body 100B may be mounted with the drain hole 115 cut, and the drain hole 115 is mounted corresponding to the through hole 170 of the first lid part 150A. As described above, when the mounting frame 160 is formed around the through hole 170, the drain hole 115 may be combined with the through hole 170 so as to correspond to the through hole 170.

The Dutch coffee machine may further include a filter 190 in the inner bottom of the second body 100B. Grinded coffee beans 180 (or ground coffee beans) may be putted into the upper part of the filter 190. In an example embodiment, two or more the second main bodies 100B may be continuously included in the vertical direction as required. When the second main body 100B is composed of a plurality of units, a coffee made by the Dutch coffee machine may be more concentrated. The second lid part 150B may be mounted on the upper part of second main body 100B.

The third main body 100C may be mounted on the upper surface of the second lid part 150B. The third main body 100C is used in a state that the drain hole 115 is cut like the second main body 100B explained above, and a structure and a method of mounting the third main body 100C may be the same as a structure and a method of mounting the second main body 100B, respectively. As described above, when the second main body 100B is composed of a plurality of units, the third main body 100C is mounted on the upper part of the second main body 100B at the uppermost part. The third main body 100C may be also composed of a plurality of units, and the third main body 100C may accept water. However, in a preferred example embodiment, the first main body 100A to the third main body 100C may be respectively included respectively one by one as shown in the figure. In addition, the third lid part 150C may be further included on the upper part of the third main body 100C to prevent foreign matters such as dust from flowing into the third main body 100C.

In the above structure, with regard to an operation principle of the Dutch coffee machine, the water accepted inside of the third main body 100C may flow into the second main body 100B along the drain hole 115. At this time, an amount of water to be discharged may be determined according to the size of the cutting portion of the drain hole 115 of the third main body 100C. Usually, the water may be allowed to flow out for a few hours by slowly dropping periodically, one by one.

The water flowing into the second main body 100B may brew primary the grinded coffee beans 180. Thereafter, foreign matter such as coffee residue in the water may be filtered through the filter 190, and then the water may flow into the first main body 100A again. Here, the amount of water to be discharged from the second body 100B to the first body 100A may be appropriately adjusted by the extension hole 130 at the upper part of the drain hole 115.

That is, the bottom surface 105 of the main body 100 (e.g., at least one of the first main body 100A, the second main body 100B, and the third main body 100C) of the cup-shaped container may be formed flat. The water permeated in the grinded coffee beans 180 may not flow easily toward the drain hole 115 except the water around the drain hole 115 due to the water cohesive force until the water permeated in the grinded coffee beans 180 coalesces with the surrounding water and reaches a certain level or more. And when the amount of water becomes more than a certain level and starts to flow in the direction of gravity, the surrounding water comes together by the cohesive force. Therefore, when there is a only the drain hole 115 without the extension hole 130, the water does not flow down for a period time, and the water is filled in the bottom surface 105 of the body 100 some extent, the water may be poured at a time. After a certain amount of water is poured, the phenomenon that water is not discharged to the drain hole 105 until the entire bottom surface 105 of the main body 100 is filled with some extent water may be repeated. But, when the expansion hole 130 is included, the water brewed from the coffee may drop by the weight of the water filled in the expansion hole 130 by one drop periodically. Since the surrounding water flows into the expansion hole 130 little by little to be always filled with a certain amount, the pressure applied the drain hole 115 may be kept constant to some extent. And in the case of the first body 100B, since the filter 190 is included in close contact to the lower part of the main body 100, water may not flow out to the drain hole 115 without the expansion hole 130. When the expansion hole 130 is included, the bottom surface of the main body 100 may be separated from the filter 190 by the width of the expansion hole 130. The bottleneck phenomenon may be reduced so that the water brewed in the expansion hole 130 may be flow in more easily. In the preferred example embodiment, the expansion hole 130 may be formed to be two to five times larger than the starting hem width of the drain hole 115. That is, the expansion hole 130 may be formed only in the center part of the bottom surface 105 of the main body 100 around the starting hem of the drain hole 115. When the expansion hole 130 extends over the entire bottom surface 105 of the main body 100, that is, when the entire bottom surface 105 of the main body 100 is formed so as to become lower toward the center, to get enough time to brew coffee may be difficult. However, the size of the expansion hole 130 is merely a preferred example and is not limited thereto. The first main body 100A may accept the water brewing coffee escaping from the drain hole 115 of the second main body 100B.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

1. A cup-shaped container capable of being converted into a Dutch coffee machine comprising
a main body of cup-shape;
a drainer protrusion with a closed structure protruded to outside from a bottom surface of the main body; and
a drain hole to connect an inside of the main body and an inside of the drainer protrusion,
wherein the cup-shape container is converted into a Dutch coffee machine by cutting off the drainer protrusion.

2. The cup-shaped container of claim 1, wherein the drain hole is formed to be narrowed toward the outside.

3. The cup-shaped container of claim 2, further comprising:
an expansion hole formed between the drain hole and inner bottom surface of the main body and to become wider toward the inner side of the bottom surface of the main body.

4. The cup-shaped container of claim 3, wherein each of the drain hole and the drainer protrusion is formed in a conical shape, and
wherein the expansion hole has a cone angle larger than a cone angle of the drain hole such that the overall shape is a funnel shape.

5. The cup-shaped container of claim 1, further comprising:
a cover on an upper opening of the main body,
wherein a through hole is formed in a center of the cover corresponding to the drain hole.

6. The cup-shaped container of claim 5, further comprising:
a mounting frame on the cover and around the through hole,
wherein a lower part of the main body is mounted on the mounting frame.

7. A Dutch coffee machine comprising:
a first main body which accepts finally a brewed coffee;
a first cover mounted on an upper part of the first main body;
a second main body including a drain hole on a bottom surface corresponding to a through hole of the first cover and brewing a coffee;
a second cover mounted on an upper part of the second main body; and
a third main body including a drain hole on a bottom surface corresponding to a through hole of the second cover and accepting water.

8. The Dutch coffee machine of claim 7, wherein the second main body includes a filter on a bottom surface of the second main body, and
wherein grinded coffee beans is included on an upper part of the filter, the water contained in the third main body flows into the second main body and brews the coffee beans, and the brewed coffee flows out to the first main body.

9. The Dutch coffee machine of claim 8, wherein the second main body and the third main body includes:
a drainer protrusion protruding outward from the bottom surface and including a drain hole inside, and
wherein the drainer protrusion and the drain hole are formed to be narrowed outward.

10. The Dutch coffee machine of claim 9, wherein the second main body further includes:
an expansion hole formed between the drain hole and inner bottom surface of the second main body and to become wider toward the inner side of the bottom surface of the second main body,
wherein the expansion hole has a cone angle larger than a cone angle of the drain hole such that overall shape of the drain hole and the expansion hole is a funnel shape.

11. The cup-shaped container of claim 2, further comprising:
a cover on an upper opening of the main body,
wherein a through hole is formed in a center of the cover corresponding to the drain hole.

12. The cup-shaped container of claim 11, further comprising:
a mounting frame on the cover and around the through hole,
wherein a lower part of the main body is mounted on the mounting frame.

13. The cup-shaped container of claim 3, further comprising:
a cover on an upper opening of the main body,
wherein a through hole is formed in a center of the cover corresponding to the drain hole.

14. The cup-shaped container of claim 13, further comprising:
a mounting frame on the cover and around the through hole,
wherein a lower part of the main body is mounted on the mounting frame.

15. The cup-shaped container of claim 4, further comprising:
a cover on an upper opening of the main body,
wherein a through hole is formed in a center of the cover corresponding to the drain hole.

16. The cup-shaped container of claim 15, further comprising:
a mounting frame on the cover and around the through hole,
wherein a lower part of the main body is mounted on the mounting frame.
